(19) United States
(12) Patent Application Publication
(10) Pub. No.: US 2023/0252586 A1
(43) Pub. Date: Aug. 10, 2023

(54) METHOD AND SYSTEM FOR ONLINE DATING INCLUDING SAFETY FEATURES AND INCENTIVE OFFERING

(71) Applicant: Eric Cohen, Miami, FL (US)

(72) Inventor: Eric Cohen, Miami, FL (US)

(21) Appl. No.: 18/165,775

(22) Filed: Feb. 7, 2023

Related U.S. Application Data
(60) Provisional application No. 63/307,904, filed on Feb. 8, 2022.

(51) Int. Cl. G06Q 50/00; G06Q 20/06; G06Q 20/10

(52) U.S. Cl. CPC G06Q 50/01; G06Q 20/065; G06Q 20/10

(57) ABSTRACT

A system for facilitating online dating over a communications network includes an application for users to create profile, view other user profiles, send/receive offers/acceptances for dates, a database for storing user records that include user profiles and virtual currency amounts, and a web server module for sending/receiving offers/acceptances for dates and adding a credit of virtual currency to a virtual currency amount in a user record for a user.

### CROSS-REFERENCE TO RELATED APPLICATIONS

This patent application claims priority to provisional patent application No. 63/307,904 filed on Feb. 8, 2022. The subject matter of provisional patent application No. 63/307,904 is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The claimed subject matter relates to the field of online dating and, more specifically, the claimed subject matter relates to processes for increasing the safety of, and the economic incentives associated with, online dating.

### BACKGROUND

Dating in modern times can be a difficult course to navigate. With the advent of internet dating, prospective suitors now have access to an increasingly larger pool of men and women to choose from. Though there are benefits to having more choices in the dating scene, there are also drawbacks. It can be more difficult, for example, to find a partner that fits a particular profile. With a larger population of people in the dating pool, it can take longer and require more effort for a person to hone in on just the right partner. This can be tedious, time-consuming and discouraging for the online dater.

Another drawback associated with the larger dating pool available in online dating today is the wide variety of individuals. Because the internet has provided access to online dating to the general population, the typical online dater will encounter people of all cultures, race, ages, locations, religions, sexual orientations, socio-economic statuses and backgrounds. Since dating preferences and practices may vary among different people, however, there are adjustments that must be made when people of differing backgrounds go on a date together. This increases the difficulty with online dating today. For example, traditionally, the man was expected to pay when dining with a woman while on a date. In contemporary times, however, this is not always the case. Sometimes, the woman will prefer to pay for the entire meal, prefer to pay for the meal some of the time or pay half of the bill (i.e., “going Dutch”). Thus, it can be tricky and awkward to determine who should pay when the bill arrives at the end of the dining experience while on a date. This situation becomes even more complicated when same-sex couples or couples of different cultural backgrounds are involved.

Yet another drawback associated with online dating today involves safety and verification. When people, particularly young women, go on a date, they often must take safety consideration into account, such as where they will meet the other person and whether there will be other people around. For this reason, online daters must often undertake to verify the identity of the person they are meeting for a date. Also, there is a fair amount of lying and deception that may occur during online dating. For example, online often lie about their height, weight or looks. Or online daters may simply use an old photo of themselves. This can be annoying and depressing for those online daters that are truthful, law abiding and

Therefore, what is needed is a system and method for improving the problems with the prior art, and more particularly for a more expedient, efficient, safe and verified method and system for facilitating online dating activities.

### BRIEF SUMMARY

In one embodiment, a system for facilitating online dating over a communications network is disclosed. The system includes: a) a first client module executing on a first client computing device communicably connected to a communications network, the first client module configured for providing one or more graphical user interfaces, over the communications network, configured for a first user to create a profile, view other user profiles, send offers for dates to other user and receive acceptances of offers for dates from other users; b) a second client module executing on a second client computing device communicably connected to the communications network, the second client module configured for providing the one or more graphical user interfaces, over the communications network, configured for a second user to create a profile, view other user profiles, receive offers for dates from other users and send acceptances of offers for dates from other users; c) a database communicably connected to the communications network, the database configured for storing a plurality of user records, wherein a user record includes a user profile and a virtual currency amount; and d) a web server module executing on a web server communicably connected to the communications network, the web server module configured for: 1) receiving a message, via the communications network, from the first user including an offer for a date with the second user; 2) transmitting a message, via the communications network, to the second user including the offer for a date with the second user; 3) receiving a message, via the communications network, from the second user accepting the offer for a date with the first user; 4) transmitting a message, via the communications network, to the first user including an acceptance of the offer for a date with the second user, and a credit of virtual currency; and 5) adding a credit of virtual currency to a virtual currency amount in a user record for the first user.

Additional aspects of the claimed subject matter will be set forth in part in the description which follows, and in part will be obvious from the description, or may be learned by practice of the claimed subject matter. The aspects of the claimed subject matter will be realized and attained by means of the elements and combinations particularly pointed out in the appended claims. It is to be understood that both the foregoing general description and the following detailed description are exemplary and explanatory only and are not restrictive of the disclosed subject matter, as claimed.

### BRIEF DESCRIPTION OF THE SEVERAL VIEWS OF THE DRAWINGS

The accompanying drawings, which are incorporated in and constitute part of this specification, illustrate embodiments of the claimed subject matter and together with the description, serve to explain the principles of the claimed subject matter. The embodiments illustrated herein are presently preferred, it being understood, however, that the claimed subject matter is not limited to the precise arrangements and instrumentalities shown, wherein:

FIG. 1 is a block diagram illustrating the network architecture of a system for facilitating online dating over a communications network, in accordance with one embodiment.

FIG. 2 is a block diagram showing the data flow of the process for facilitating online dating over a communications network, according to one embodiment.

FIG. 3 is a flow chart depicting the general control flow of a process for facilitating online dating over a communications network, according to one embodiment.

FIG. 4 is a block diagram depicting a system including an example computing device and other computing devices.

### DETAILED DESCRIPTION

While the claimed embodiments may be described, modifications, adaptations, and other implementations are possible. For example, substitutions, additions, or modifications may be made to the elements illustrated in the drawings, and the compositions and methods described herein may be modified by substituting, reordering, or adding elements to the disclosed compositions or stages to the disclosed methods. Accordingly, the following detailed description does not limit the claimed embodiments. Instead, the proper scope of the claimed embodiments is defined by the appended claims.

The disclosed embodiments improve upon the problems with the prior art by providing a safe and verified method and system for facilitating online dating activities. The claimed embodiments verify the identity of an online dating user and the veracity of photographs used in the dating profile. Therefore, the disclosed embodiments reduce or eliminate instances of catfishing and lying about looks or age. This is advantageous for users, as it provides a level of comfort that a user will meet the person he or she intends to meet in person. An additional benefit of the disclosed embodiments is the prearrangement of a date. The main benefit of the claimed subject matter is the improvement of the conventional online dating experience by figuring out the details of a date (location and time) beforehand. The claimed subject matter allows for many of the disadvantages of online dating to be improved upon.

The claimed embodiments further solve the problems with the prior art by providing a simple and user-friendly computer system for allowing online dating individuals to find others that match a desired profile and then make dating plans with those other individuals, wherein the subject of who pays for the date is predetermined, thereby avoiding the awkwardness of deciding who pays for a date. The claimed embodiments are advantageous since they allow for the online dating individuals to focus on getting to know each other and avoid wasting time and worry about awkward social protocols, such as deciding who should pay for a date.

Additionally, the claimed embodiments improvs upon the prior art by providing technologically advanced methods for advertising and promotion in an online dating environment. The claimed embodiments employ the use of push technology to push coupons and ads to users. This is advantageous as it facilitates commerce over a communications network and speeds up the process of fielding coupons and ads to a user base. Additionally, the claimed embodiments improve upon the prior art by providing the inviting individual with offers or discounts for a date at a particular establishment. If the offer or discount is accepted, the identity of the hotel, resort, restaurant is included in the date invitation to the invitee, thereby enticing him or her to accept the invitation.

Many men and woman often need an extra advantage to make up for what might be something they lack—perhaps they are not good looking or too short—and thus the offer of a free date or meal at a fine restaurant is a way to compensate for this lack of attractiveness. By sending a date invitation to join them for dinner, this can even the dating field, as it presents a real offer that can be acted upon immediately as a way to make the individual more desirable and attractive, and raise the probability of an acceptance of a date and an actual hook-up for a relationship.

A unique feature of the claimed embodiments is that it offers its members the ability to couple a choice of restaurants from a listing of restaurants in different ethnic menus and price venues for different economic member levels. Where the sending member as an added incentive gets a coupon incentive to choose certain restaurants based on the group buying or deal of the day coupon model. This added feature is used as a method to increase the appeal of the member and his dating offer, and thus the chance of the receiving member accepting the date invitation.

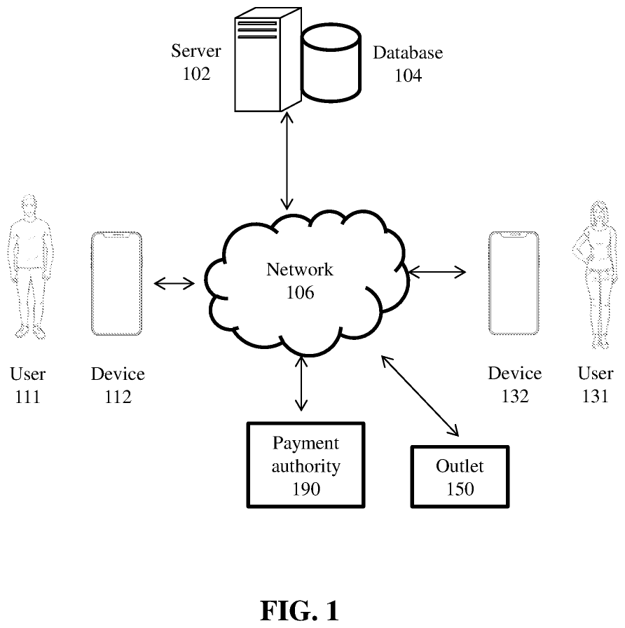

Referring now to the drawing figures in which like reference designators refer to like elements, there is shown in FIG. 1 an illustration of a block diagram showing the network architecture of a system 100 and method for facilitating online dating over a communications network in accordance with one embodiment. A prominent element of FIG. 1 is the server 102 associated with repository or database 104 and further communicatively coupled with network 106, which can be a circuit switched network, such as the Public Service Telephone Network (PSTN), or a packet switched network, such as the Internet or the World Wide Web, the global telephone network, a cellular network, a mobile communications network, or any combination of the above. Server 102 is a central controller or operator for functionality of the disclosed embodiments, namely, facilitating online dating between users.

FIG. 1 includes mobile computing devices 112, 132, which may be smart phones, mobile phones, tablet computers, handheld computers, laptops, or the like. In another embodiment, mobile computing devices 112, 132, are workstations, desktop computers, servers, laptops, all-in-one computers, or the like. In another embodiment, mobile computing devices 112, 132, are AR or VR systems that may include display screens, headsets, heads up displays, helmet mounted display screens, or the like. FIG. 1 also shows a server, computer, or mobile computing device 102 corresponding to a web server. Devices 102, 112, 132 may be communicatively coupled with network 106 in a wired or wireless fashion. Augmented reality (AR) adds digital elements to a live view often by using a camera on a computing device. Virtual reality (VR) is a complete or near complete immersion experience that replaces the physical world.

FIG. 1 further shows that server 102 includes a database or repository 104, which may be a relational database comprising a Structured Query Language (SQL) database stored in a SQL server. Devices 102, 112, 132 may also each include their own database. The repository 104 serves data from a database, which is a repository for data used by server 102 and devices 112, 132 during the course of operation of the disclosed embodiments. Database 104 may be distributed over one or more nodes or locations that are connected via network 106.

The database 104 may include a user record for each user 111 or 131. A user record may include: contact/identifying information for the user (name, address, telephone number(s), email address, etc.), information pertaining to virtual currency associated with the user, contact/identifying information for friends of the user, electronic payment information for the user, information pertaining to the purchases made by the user, sales transaction data associated with the user, etc. A user record may also include a unique identifier for each user, a residential address for each user, the current location of each user (based on location-based services from the user's mobile computer) and a description of past virtual currency purchased by each user. A user record may further include demographic data for each user, such as age, sex, income data, race, color, marital status, etc. A user record may also include contact information (email address, name, address, telephone number, etc.) or a unique identifier for one or more friends or acquaintances of the user. A user record may also include a user profile.

A user profile is user data that is meant to be seen by others, such as a photograph, a video, an age, a sex, a race, a location, a height, a weight, a socio-economic status indicator, a religion and a sexual orientation. A user profile may include any data that is found in a user record. A user profile may also include a virtual currency amount that is currently owned by the user. Virtual currency, or virtual money, is a digital currency that is largely unregulated, issued and usually controlled by its developers, and used and accepted electronically among the members of a specific virtual community. Virtual currency may include cryptocurrency, credits, or digital currency. Digital currency (digital money, electronic money, or electronic currency) is any currency, money, or money-like asset that is primarily managed, stored or exchanged on digital computer systems, especially over the internet. Types of digital currencies include cryptocurrency, virtual currency, and central bank digital currency. Digital currency may be recorded on a distributed database on the internet, a centralized electronic computer database owned by a company or bank, within digital files or even on a stored-value card.

Sales transaction data may include one or more product/service identifiers (such as SKUs), one or more product/service amounts, buyer contact/identifying information, brick and mortar outlet information, and electronic payment information. In one embodiment, electronic payment information may comprise buyer contact/identifying information and any data garnered from a purchase card (i.e., purchase card data), as well as any authentication information that accompanies the purchase card. Purchase card data may comprise any data garnered from a purchase card and any authentication information that accompanies the purchase card. In one embodiment, electronic payment information may comprise user login data, such as a login name and password, or authentication information, which is used to access an account that is used to make a payment.

In one embodiment, photographs of user in their used profile are time stamped and verified by server 102. This can be a requirement of use of the system 100, and if a user refuses, the user may still post a picture, but it will be marked as not being time stamped and verified. This feature ensure that users a truthful in posting pictures and reduces or eliminates catfishing.

FIG. 1 shows an embodiment wherein networked computing devices 112, 132 interact with server 102 and repository 104 over the network 106. It should be noted that although FIG. 1 shows only the networked computers 112, 132 and 102, the system of the disclosed embodiments supports any number of networked computing devices connected via network 106. Further, server 102, and units 112, 132 include program logic such as computer programs, mobile applications, executable files or computer instructions (including computer source code, scripting language code or interpreted language code that may be compiled to produce an executable file or that may be interpreted at run-time) that perform various functions of the disclosed embodiments.

Note that although server 102 is shown as a single and independent entity, in one embodiment, the functions of server 102 may be integrated with another entity, such as one of the devices 112, 132. Further, server 102 and its functionality, according to a preferred embodiment, can be realized in a centralized fashion in one computer system or in a distributed fashion wherein different elements are spread across several interconnected computer systems.

FIG. 1 also shows a payment authority 190, which acts to effectuate payments by users 111 or 131 for online dating services, virtual currency, gifts, or the like. In the course of a sales transaction, server 102 may interface with payment authority 190 to effectuate payment. In one embodiment, the payment authority 190 is a payment gateway, which is an e-commerce Application Service Provider (ASP) service that authorizes and processes payments from one party to another. The payment authority 190 may accept payment via the use of purchase cards, i.e., credit cards, charge cards, bank cards, gift cards, account cards, etc.

FIG. 1 also shows a brick and mortar outlet 150, which represents the physical presence of an organization or business in a building or other structure. The outlet 150 may be a retail store, a restaurant, a cafeteria, a music venue, a sports venue, a theater, an arena, a stage, an amphitheater, an outdoor concert structure, stadium, bandshell, bandstand, concert hall, opera house, nightclub, discotheque, park, bar, pub, sports complex, etc. The outlet server 160 may also represent the information technology infrastructure, including servers and computers, which are used by the brick and mortar outlet 150 to manage virtual gifts.

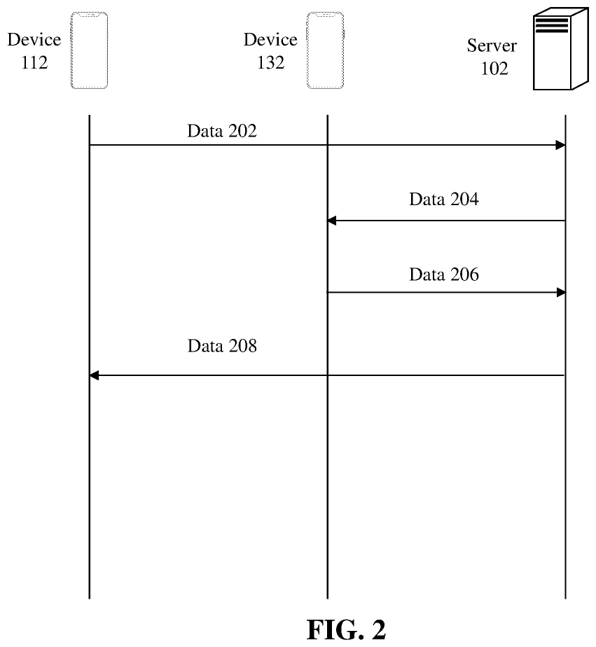

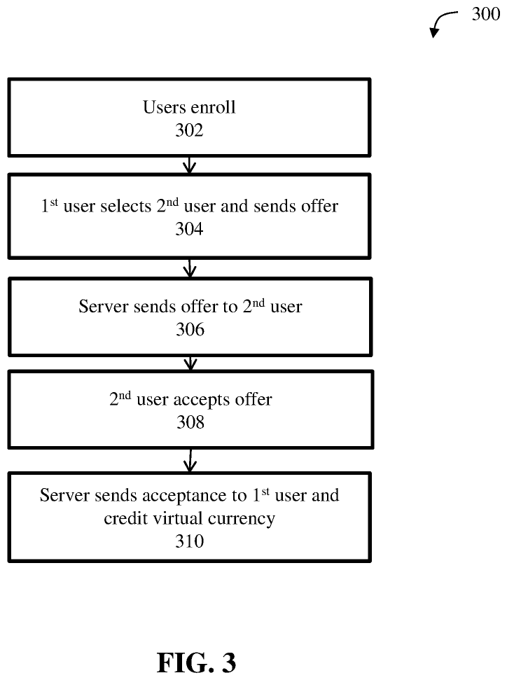

The process of facilitating online dating over a communications network will now be described with reference to FIGS. 2-3 below. FIGS. 2-3 depict the data flow and control flow of the process for facilitating online dating over a communications network 106, according to one embodiment. The process of the disclosed embodiments begins with optional step 302 (see flowchart 300), wherein the users 111 and 131 may enroll or register with server 102. In the course of enrolling or registering, the users may enter data into their devices (112, 132) by manually entering data into a mobile application (client module) via keypad, touchpad, or via voice. In the course of enrolling or registering, the users may enter any data that may be stored in a user record, as defined above.

Also in the course of enrolling or registering, the server 102 may generate a user record for each registering user and store the user record in an attached database, such as database 104. Also in the course of enrolling or registering, a user may make a payment for enrolling. When making said purchase, the user's electronic payment information is transmitted by server 102 to payment authority 190 for processing. The payment authority 190 processes the electronic payment information and verifies whether payment has been effectuated. If so, the payment authority 190 may send a verification message to the server 102 thereby verifying that the payment has been effectuated.

Subsequently, in step 304, the user 111 views user profiles and selects user 131 for an offer for a date or meal. The user 111 may view the user profiles and select user 131 utilizing a client module executing on his mobile computing device 112. The client module is configured for transmitting, via network 106, a message or request (i.e., data packet 202), such as an HTTP request, to server 102 to send an offer for a date or meal to user 131. In one alternative, the server 102 compares user records or user profiles and if there is a match in their user records or user profiles, the server 102 recommends user 131 to user 111 for a date or meal offer. The offer may include a date, a time, an identification of a restaurant and a promise to pay for the date.

In step 306, the server module executing on server 102 receives, via network 106, the request (i.e., data packet 202) from user 111 and transmits, via network 106, a message or request (i.e., data packet 204) to the client module executing on the mobile computing device 132 of user 131, wherein the message include an offer having a date, a time, an identification of a restaurant and a promise to pay for the date.

In the next step 308, the client module executing on the mobile computing device 132 of user 131 receives, via network 106, the offer for the date and accepts it. Also in step 308, the client module executing on the mobile computing device 132 of user 131 transmits, via network 106, an acceptance of the offer to the server module executing on server 102. I.e., the device 132 transmits a message or request (i.e., data packet 206) to the server module, wherein said message include an acceptance of the offer.

In step 310, the server module executing on server 102 receives, via network 106, the acceptance from user 131 and transmits, via network 106, a message or request (i.e., data packet 208) to the client module executing on the mobile computing device 112 of user 111, wherein the message includes the acceptance and a credit of virtual currency. Also in step 310, the user record for the user 111 is credited a virtual currency amount. Said virtual currency can be used as an incentive to users to enroll (see above), to be used for discounts on services, and products that may be offered. The virtual currency may be used to purchase goods and services at accepting establishments and product manufacturers as an incentive to have the receiver of a date request accept an invitation. The virtual currency may also be used simply as a gift to continue to date, or as an appreciation of a relationship.

In one embodiment, dates are set in a restaurant based on zip codes near both parties, not to exceed 60 miles based on the zip codes of the parties. This feature offers the advantage of a safe place to meet in a restaurant close to the parties. This an important advantage because it makes the dating experience geographically convenient and safe. Further, in another embodiment, a party can, with a push of a button, expand his or her dating search in any zip code entered into the interface.

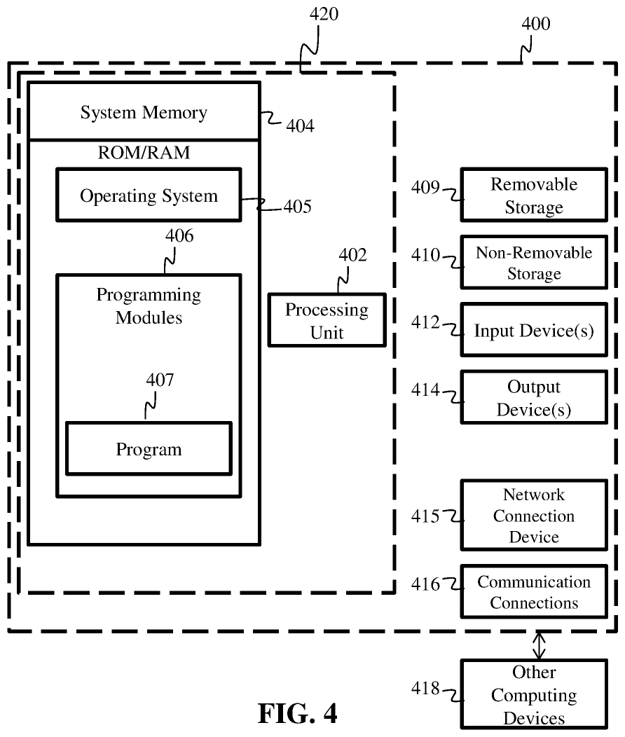

FIG. 4 is a block diagram of a system including an example computing device 400 and other computing devices. Consistent with the embodiments described herein, the aforementioned actions performed by 102, 111, 132 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for system 100 and process 300, as described above. Process 300 may operate in other environments and are not limited to computing device 400.

With reference to FIG. 4, a system consistent with an embodiment may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random-access memory (RAM)), non-volatile (e.g. read-only memory (ROM)), flash memory, or any combination or memory. System memory 404 may include operating system 405, and one or more programming modules 406. Operating system 405, for example, may be suitable for controlling computing device 400's operation. In one embodiment, programming modules 406 may include, for example, a program module 407 for executing the actions of units 102, 111, 132. Furthermore, embodiments may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. Computing device 400 may also include a vibration device capable of initiating a vibration in the device on command, such as a mechanical vibrator or a vibrating alert motor. The aforementioned devices are only examples, and other devices may be added or substituted.

Computing device 400 may also contain a network connection device 415 that may allow device 400 to communicate with other computing devices 418, such as over a network in a distributed computing environment, for example, an intranet or the Internet. Device 415 may be a wired or wireless network interface controller, a network interface card, a network interface device, a network adapter or a LAN adapter. Device 415 allows for a communication connection 416 for communicating with other computing devices 418. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 (e.g. program module 407) may perform processes including, for example, one or more of the stages of the process 300 as described above. The aforementioned processes are examples, and processing unit 402 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist.

Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system for facilitating online dating, the system comprising:
a) a first client module executing on a first client computing device communicably connected to a communications network, the first client module configured for providing one or more graphical user interfaces, over the communications network, configured for a first user to create a profile, view other user profiles, send offers for dates to other user and receive acceptances of offers for dates from other users;
b) a second client module executing on a second client computing device communicably connected to the communications network, the second client module configured for providing the one or more graphical user interfaces, over the communications network, configured for a second user to create a profile, view other user profiles, receive offers for dates from other users and send acceptances of offers for dates from other users;
c) a database communicably connected to the communications network, the database configured for storing a plurality of user records, wherein a user record includes a user profile and a virtual currency amount; and
d) a web server module executing on a web server communicably connected to the communications network, the web server module configured for:
1) receiving a message, via the communications network, from the first user including an offer for a date with the second user;
2) transmitting a message, via the communications network, to the second user including the offer for a date with the second user;
3) receiving a message, via the communications network, from the second user accepting the offer for a date with the first user;
4) transmitting a message, via the communications network, to the first user including an acceptance of the offer for a date with the second user, and a credit of virtual currency; and
5) adding a credit of virtual currency to a virtual currency amount in a user record for the first user.

2. The system of claim 1, wherein the step of receiving a message from the first user further comprises receiving an HTTP request from the first client module executing on the first client computing device.

3. The system of claim 2, wherein the step of receiving a message from the second user further comprises receiving an HTTP request from the second client module executing on the second client computing device.

4. The system of claim 3, wherein an offer for a date includes a date, a time, an identification of a restaurant and a promise to pay for the date.

5. The system of claim 4, wherein a user profile includes one or more of: an age, a sex, a race, a location, a height, a weight, a socio-economic status indicator, a religion, and a sexual orientation.

6. The system of claim 5, wherein a message comprises an email, a text, or a textual message displayed in a graphical user interface.

7. A system for facilitating online dating, the system comprising:
a) a first client module executing on a first client computing device communicably connected to a communications network, the first client module configured for providing one or more graphical user interfaces, over the communications network, configured for a first user to create a profile, view other user profiles, send offers for meals to other user and receive acceptances of offers for meals from other users;
b) a second client module executing on a second client computing device communicably connected to the communications network, the second client module configured for providing the one or more graphical user interfaces, over the communications network, configured for a second user to create a profile, view other user profiles, receive offers for meals from other users and send acceptances of offers for meals from other users;
c) a database communicably connected to the communications network, the database configured for storing a plurality of user records, wherein a user record includes a user profile and a virtual currency amount; and
d) a web server module executing on a web server communicably connected to the communications network, the web server module configured for:
1) receiving a message, via the communications network, from the first user including an offer for a meal with the second user;
2) transmitting a message, via the communications network, to the second user including the offer for a meal with the second user;
3) receiving a message, via the communications network, from the second user accepting the offer for a meal with the first user;
4) transmitting a message, via the communications network, to the first user including an acceptance of the offer for a meal with the second user, and a credit of virtual currency; and
5) adding a credit of virtual currency to a virtual currency amount in a user record for the first user.

8. The system of claim 7, wherein the step of receiving a message from the first user further comprises receiving an HTTP request from the first client module executing on the first client computing device.

9. The system of claim 8, wherein the step of receiving a message from the second user further comprises receiving an HTTP request from the second client module executing on the second client computing device.

10. The system of claim 9, wherein an offer for a meal includes a date, a time, an identification of a restaurant and a promise to pay for the meal.

11. The system of claim 10, wherein a user profile includes one or more of: an age, a sex, a race, a location, a height, a weight, a socio-economic status indicator, a religion, and a sexual orientation.

12. The system of claim 11, wherein a message comprises an email, a text, or a textual message displayed in a graphical user interface.

13. A system for facilitating online dating, the system comprising:
a) a first client module executing on a first client computing device communicably connected to a communications network, the first client module configured for providing one or more graphical user interfaces, over the communications network, configured for a first user to create a profile, view other user profiles, send offers for dates to other user and receive acceptances of offers for dates from other users;
b) a second client module executing on a second client computing device communicably connected to the communications network, the second client module configured for providing the one or more graphical user interfaces, over the communications network, configured for a second user to create a profile, view other user profiles, receive offers for dates from other users and send acceptances of offers for dates from other users;
c) a database communicably connected to the communications network, the database configured for storing a plurality of user records, wherein a user record includes a user profile and a virtual currency amount; and
d) a web server module executing on a web server communicably connected to the communications network, the web server module configured for:
1) receiving a message, via the communications network, from the first user including an offer for a date with the second user, wherein the offer includes a promise to pay for the date;
2) transmitting a message, via the communications network, to the second user including the offer for a date with the second user;
3) receiving a message, via the communications network, from the second user accepting the offer for a date with the first user;
4) transmitting a message, via the communications network, to the first user including an acceptance of the offer for a date with the second user, and a credit of virtual currency; and
5) adding a credit of virtual currency to a virtual currency amount in a user record for the first user.

14. The system of claim 13, wherein a user profile includes one or more of: an age, a sex, a race, a location, a height, a weight, a socio-economic status indicator, a religion, and a sexual orientation.

15. The system of claim 14, wherein a user profile includes a photograph of a user, wherein said photograph has been time stamped and verified by the web server module.

16. The system of claim 15, wherein web server module is further configured to offer virtual currency to users as an incentive to enroll with the web server.

17. The system of claim 16, wherein web server module is further configured to suggest a location for a date to the first and second users based on a zip code of both the first and second user, wherein the web server module selects the location for the date such that it is within a threshold distance of the zip code of both the first and second user.
